(19) United States
(12) Patent Application Publication
(10) Pub. No.: US 2012/0063713 A1
(43) Pub. Date: Mar. 15, 2012

(54) ROLLER BEARING WITH A SEGMENTED CAGE

(76) Inventor: Werner Beuerlein, Volkach (DE)

(21) Appl. No.: 13/254,888

(22) PCT Filed: Mar. 3, 2010
(86) PCT No.: PCT/DE10/00243

§ 371 Date: Nov. 28, 2011

(30) Foreign Application Priority Data
Mar. 7, 2009 (DE) 10 2009 012 241.9

(51) Int. Cl. F16C 33/50; F16C 33/56

(52) U.S. Cl. 384/576; 384/578

(57) ABSTRACT

Roller bearing with a segmented cage for guiding the roller bodies, said cage comprising an inner ring on which a plurality of roller bodies can roll, and which can also roll on an outer ring which is concentric to the inner ring, a cage consisting of a plurality of webs which are distributed in a uniform manner over the periphery and which are aligned so as to be parallel to each other and to the longitudinal axis of the cage, and a plurality of lateral plates for joining the webs, two webs and two lateral faces being firmly connected to one another to form a cage segment, which forms a pocket for guiding a roller body and all cage segments are connected to one another in pairs to form an inherently closed cage.

The invention relates to a roller bearing with a segmented cage for guiding the roller bodies, said cage comprising an inner ring on which a plurality of roller bodies can roll, and which can also roll on an outer ring which is concentric to the inner ring, a cage consisting of a plurality of webs which are distributed in a uniform manner over the periphery and which are aligned so as to be parallel to each other and to the longitudinal axis of the cage, and a plurality of lateral plates for joining the webs.

In a roller bearing, roller bodies, such as balls, cylindrical rollers, cones, pins or barrel-shaped toroids roll both on the outside of the inner ring and on the inner side of the outer ring, the inner and outer ring being rotatable with respect to one another. Under uniform, stationary loading of the roller bearing, the load is distributed approximately uniformly on all roller bodies, so that they contact both the inner and outer ring. In this case, the uniform distance between all roller bodies is also maintained.

As a result of impact loading and/or non-uniform heating, however, the load can be temporarily concentrated on a few roller bodies, so that other, currently less heavily loaded roller bodies lose contact with a ring and as a consequence lose their position within the roller bearing, and can impact on another roller body. Then the two roller bodies rub against one another and can be damaged. As soon as non-round running of the bearing results, the other roller bodies are also displaced from their position, impact on one another and are also damaged. In this case, the bearing must be replaced.

To avoid that, cages are known that maintain the unloaded roller bodies at the provided distance from their neighbours. To this end, they must be in contact with the roller bodies. Depending on the design, the cages also support the inner ring or the outer ring.

In any case, they are not only subject to forces acting tangentially, but also to considerable forces in the radial direction. The cages must therefore also be designed sufficiently robustly.

Each cage forms a so-called “pocket” for each roller body, in which it guides the roller body. The guide is either only loose, so that the roller body can still move somewhat within the pocket. Or the guide is so firm, that the roller body is still held by the cage even when the cage is taken out of the bearing. In any case, the cage is always a complex part that required complicated manufacturing.

To reduce the manufacturing complexity, various proposals are known in the prior art, for producing the cage not in one part but in parts and to assemble the parts into a complete, self-contained annular cage.

The U.S. Pat. No. 6,666,585 discloses a cage that is assembled from two annular parts. The outer ring contains openings that lie on the outwardly facing side of the roller body, the inner ring has fork-like extensions, which bear against the inner side of the roller body. Both parts are assembled by means of a snap connection to form a complete cage.

Although the production of the individual parts is somewhat facilitated thereby, the cage must be produced in casting moulds and be further machined and mounted on cutting machines, which can receive the complete diameter of the cage.

To drastically reduce these components patent IDE 840 175 proposes that each roller body is held by sheet-metal profile which is bent into a U-shape and has an opening, through which a portion of the roller body projects. Adjacent U-shaped sheet-metal profiles contact themselves in each case by their legs. Any solid connection between the U-shaped sheet-metal profiles as segments of a cage is, however, expressly not provided. The maintenance of the necessary spacing between the roller bodies should thus take place exclusively via the loose series arrangement of the U-shaped sheet-sheet-metal profiles, which are conceived as a cage segment in this case.

This arrangement has the advantage that the U-shaped sheet-metal profiles can only be adapted to roller bearings with different diameters by slight inward or outward bending of their legs.

An important disadvantage, however, is that they can only receive the forces occurring during non-uniform loading of the rolling bodies to a very limited extent. Under strong load impacts, the urgently necessary supporting effect of the cage is lacking and the roller bodies leave their correct positions. Even if only the sheet-metal profiles are thereby bent, they continue to rub against other elements and can force out the bearing grease, as a result of which the roller bearing fails prematurely.

The application of the aforementioned property right in German Patent DE 874 683 has therefore connected all U-shaped cage segments together by a surrounding solid steel ring, which is inserted in lateral slits in the two flanks of each U-shaped cage segment

Although the previously very unstable cage very much stronger against forces acting in the radial direction, but disadvantageously, with the ring, a part is required that is to be carefully matched to the diameter of the bearing in each case.

Against this background, it is the aim of the invention to develop a segmented cage for roller bearings,
Which is free of rings that are inherently closed and adapted to the required diameter, and
which contains a plurality of cage segments to receive, overall, a roller body, and
Which can be assembled from, in each case, identical cage segments to form closed cages of various diameters,
   the segments being connected together such that the torques can be transmitted around the longitudinal axis of the cage.

As a solution, the invention teaches that a cage segment consists of at least one web and two lateral plates, and for a small variation of the diameter, the webs and the lateral plates of a cage segment have a limited elasticity, which permits identical cage segments in different numbers to be firmly connected to form an inherently closed annular cage, and for a larger variation of the diameter, intermediate wedges can be inserted between the webs of adjacent cage segments, of which the connecting surfaces to the webs are formed so as to be complementary to the outer sides thereof, and variants of the intermediate wedges can be assembled with different angles between their two connecting surfaces with in each case identical cage segments to form cages with different diameters.

It is a significant feature of the invention that the cage segments can be assembled to form cages with different diameters. For a small variation of the diameter, the elasticity of directly adjacently placed cage segments is exploited so that, for example, instead of nine cage segments, ten segments are assembled to form a ring, the diameter of which is then larger or only eight segments are connected together to form a cage with smaller diameter. By virtue of the stresses that are thereby exerted on the connection, the connecting element is also subjected to a certain pressure under peak loads, so that the connection surfaces are pressed against one another and the stability of the cage is thereby increased.

If the variance of the diameter, however, ought to be greater, the invention proposes that, between the webs of adjacent cage segments, intermediate wedges are inserted, of which the connecting surfaces to the webs are formed so as to be complementary to the outer sides of the cage segments. When these intermediate wedges are produced in multiple versions with different angles between their two connecting surfaces, they can, by the combination of ever identical cage segments with Intermediate wedges of different angles, for cages of very small or very large diameter. The costs for production, as well as for using the cages, are thereby greatly reduced, since the number of parts to be considered is dramatically reduced.

A feature of the invention is thus that each cage segment for, in total, one roller body in each case, provides an own pocket, there being formed, in an embodiment comprising two webs and two lateral faces, a frame-shaped element, which encloses the roller bodies.

In a second variant, a cage segment consists of a web and two lateral faces, which are connected together in an H-shaped manner. On each side of the web, a portion of a pocket is formed for the roller body, which complements the partial pocket of the adjacent, also H-shaped, cage segment to form a complete pocket.

In the first frame-shaped embodiment, the frame, unlike the presented prior art, is already in itself a relatively stable assembly. Also in contrast to the aforementioned prior art, this assembly is firmly connected, over relatively large cross-sectional areas, to other similar assemblies and closed to form an annular cage. Due to the fixed formation of the frame-like cage segments per se, and due to the firm connection of the cage segments to one another, there occurs an overall very solid and load-bearing cage, which can also hold all roller bodies permanently in their position even under load impacts and peak loads.

Due to the load-bearing connection between the two cage elements, radially acting forces can be transmitted from one cage segment to the adjacent cage segment and from there to further cage segments so that roller bodies even temporarily lifted from the inner ring or from the outer ring of the roller bearing can be held in their correct distance from the adjacent roller body.

The load bearing capacity of the connection of the cage segments to one another is reached by the design, typical of the invention, of the lateral plates, which, as plate-shaped elements, are considerably thinner in the axial direction of the cage segment than in the radial direction. Because the end faces of each lateral plate continue through the end of each adjacent web, the next contiguous lateral plate bears thereon with its entire end face. Thereby torques can be transmitted around the longitudinal axis of each cage segment to the adjacent cage segment without the angle between the two cage segments being significantly changed. Thus, a secure guidance of the roller bodies is achieved even in the event of load impacts.

In all alternative embodiments, too, the lateral plates are joined in a load-bearing manner at the end faces to the end faces of the lateral plates of both adjacent cage segments. By virtue of the joining of all cage segments, all lateral plates are connected into an annual polygon, which stabilizes the cage to the necessary extent.

The invention prefers the adjacent cage segments to be connected together at their webs. As an alternative embodiment, a connection only via the lateral plates is also possible.

Although it is conceivable to assemble the individual cage segments from individual parts, for example by means of welded or adhesively bonded webs and lateral plates. The invention prefers the cage segments to be formed as one-pail injection mouldings, die castings or other cast parts.

It is particularly interesting to produce the cage segments from polyamide or polyphthalamide or polyetherketone (PEK) or polyether ether ketone (PEEK) or polyamide-imide (PAI) or polyimide (PI) or phenolic resin. These plastics have a proven track record for roller bearing cages and offer the advantage of a particularly low dynamic friction with the roller bodies. Plastic is much more cost-effective than metal. After casting, it generally does not need to be further processed. A plastic cage permits smoother running of the bearing and is also suitable for emergency running without lubrication of the bearing.

To increase the mechanical strength of each cage segment, glass fibres and/or other fibres and/or glass spheres and/or other fillers can be admixed with the plastic. Thereby, not only is the mechanical resistance considerably increased, but also the shrinkage during cooling of the plastic. In particular due to the admixture of glass spheres, the shrinkage is approximately uniform in both directions of the plastic.

Alternatively, the cage segments can also be made of metal, such as sheet metal, which is punched and folded. It is also possible to use brass parts, which are assembled from individual parts to form a cage segment. Or the cage segment is a one-part brass part. A proven material for cages, and thereby also for cage segments is grey cast iron. It should be observed that a cage segment of metal is significantly more expensive than one of plastic. The dynamic friction with respect to the roller bodies is very much worse than in the case of plastic. The only advantage is greater mechanical stability.

The sliding properties of metal cage segments can also be improved in one alternative embodiment by means of sliding bearings of plastic, which are placed on those surfaces by which the cage segment comes into contact with the roller body. However, such a design requires significant additional outlay.

A significant feature of the cage segment according to the invention is the load-bearing and highly robust connection to both adjacent cage segments. As a connection, the invention prefers that a slot is formed in the outside of the first web of each cage segment, and a key is formed on the outside of the second web, which is complementary to the slot.

The profile of the key and slot is arbitrary in the most general case. A very interesting alternative embodiment is a dovetail form for the key and slot. This connection permits pressing of the two mutually contacting outer surfaces of both webs and thereby also the transmission of torques, which are generated by radial forces on the cage and are effective around the longitudinal axis of the cage.

An alternative embodiment is a keyhole-like profile of the slot, in which a complementary, approximately head-like profile can be inserted. Many other alternatives with an undercut are conceivable.

In the case of these and other alternative embodiments, the two segments to be joined together are always inserted one into the other in order to assemble them. To facilitate assembly, one side of the profile of the spring can be tapered somewhat.

An alternative to this is a slot without an undercut, in which a tongue is formed approximately in the centre, which can be plugged into a depression in the centre of the key that is complementary thereto. Both by virtue of the tongue and by both portions of the key, there runs parallel to the longitudinal axis of the cage a bore, into which a securing pin or a screw fastening can be pushed.

Alternatively to the screw fastening, other connections of the individual segments are also possible, such as adhesive bonding or welding, but also friction welding.

In the case of cage segments designed in an H-shape, the invention proposes, as alternative to the intermediate wedges, that the lateral plates of a cage segment are extended and, with their extension, lie on the lateral plate of the adjacent cage segment. Various angles between the two mutually contacting lateral plates can be adjusted. They can be fixed by a suitable connection so that the two adjacent cage segments are secured at this angle.

To set an angle, a plurality of snap connections can be provided, of which only one is used. Then, a stepwise adjustment is possible. Intermediate values can be achieved within the scope of the elasticity of the cage elements. An alternative embodiment is a screw fastening, another possibility is a serration with different angular steps. The two lateral plates lying one an the other are either pressed together during assembly by means of a corresponding predeformation and elastic separation of the side, or secured by means of a screw fastening and/or an adhesive fastening. However, all other known connections are also conceivable.

As a result, after installation, a rigid connection is achieved between the individual cage segments, which permits torques to be transferred from one cage segment to the next.

It is appropriate for the pivoting of the cage segments with respect to one another for setting of the diameter during assembly of the cage to take place on the respective axis of the guided roller body. In this case, all regions of contiguous cage segments have the same distance from the roller body, independently of the respective angle, and therefore also a uniform guiding behaviour.

Each variant of a cage segment contains a pocket for a roller body, which can be formed as a sphere, cylindrical roller, cone, pin or barrel-shaped toxoid. But for each other rotationally symmetrical form of a roller body, a partially complementary pocket can be formed in the cage segment.

The principle of a segmented cage can be used both on roller bearings for radial loading and on designs for axial loading and on hybrid designs—so-called angular contact bearings. Segmented cages according to the invention can also be configured for spherical roller bearings and for tandem roller bearings.

Further details and features of the invention are described below with reference to an example. This is not intended to restrict the invention, but only to explain it. In schematic view,

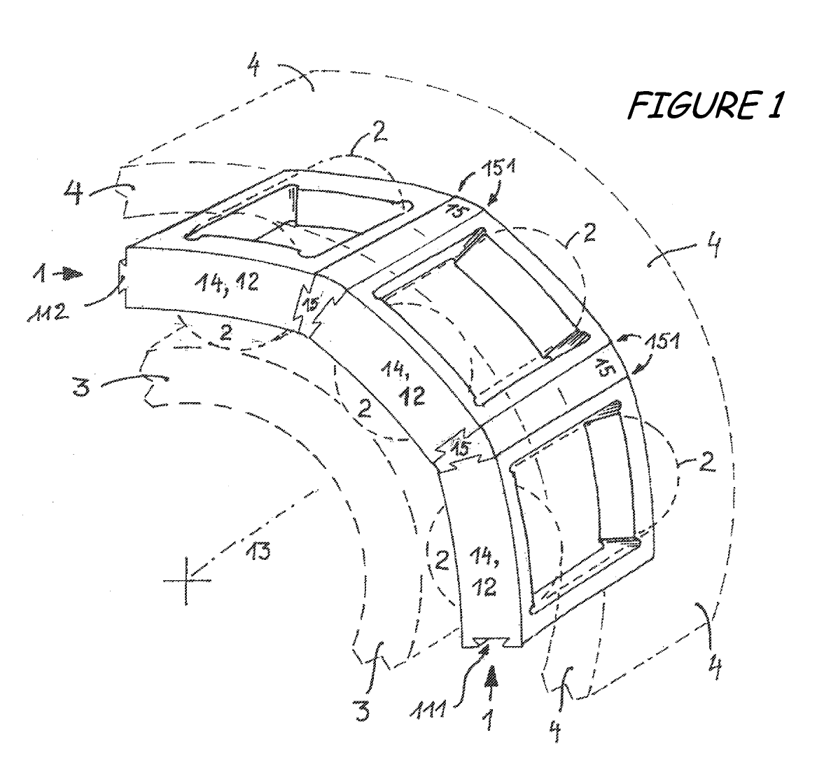

FIG. 1 shows a section of a cage

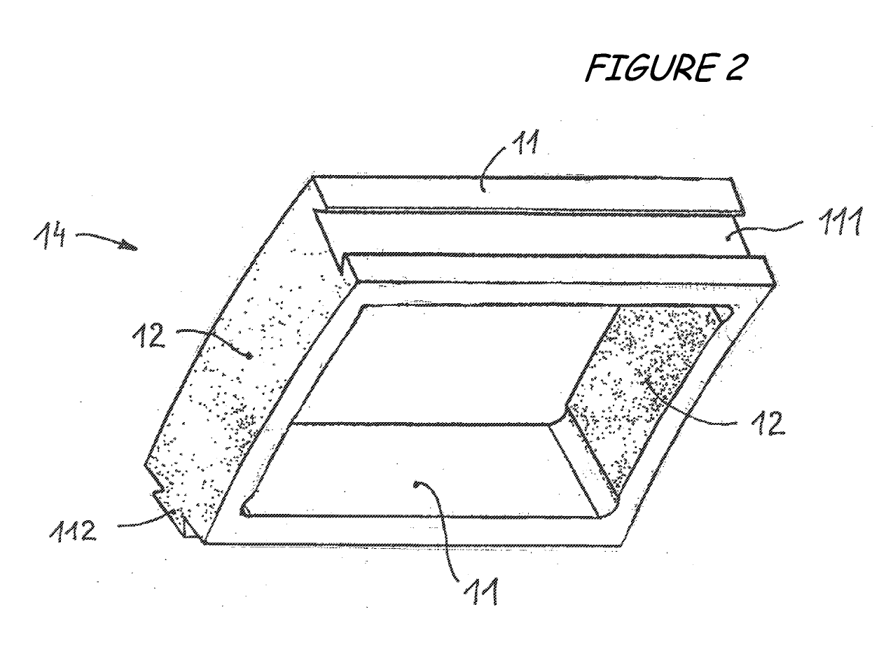

FIG. 2 shows an oblique view of a frame-like cage segment.

In detail, the figures show:

In FIG. 1, as section, a quarter circle of a cage (1) is shown, which consists of three cage segments (14), which are joined together via intermediate wedges (15) in each case. Each segment (14) guides a roller body (2)—shown here with a broken line. Each roller body (2) rolls on the inner ring (3) and the outer ring (4)—which are also shown as broken lines. In FIG. 2 it is readily apparent how solid the connection of the cage segments (14) and the intermediate wedge (15) is thanks to the plate-like dimensioning of the lateral plates (12) of each cage segment.

In the embodiment shown in FIG. 1, it is readily apparent that the lateral plates (12) of the cage segments (14) have a slight curvature, but, due to the insertion of an intermediate wedge (15), have been adapted to a relatively small diameter. To this end, the two connecting faces (151) of each intermediate wedge (15) have an acute angle to one another. In FIG. 1, it can be seen that the cage segments (14) are connected to one another via slots (111) and keys (112). Complementary slots (111) and keys (112) are also arranged on the connecting faces (151) of the intermediate wedges (15).

In FIG. 1 it is clearly recognisable that the cage segments (14) and the intermediate wedges (15) can be pushed together in the axial direction in each case. Due to the elasticity of the plastic, a certain oversize of the keys (112) is possible, so that they can be pressed into the slot (111) and thereby a good seating and firm connection are ensured.

In FIG. 2, a single cage segment (14) is drawn in skew projection. The area of the cage segment (14) that faces the inner ring (3) is shaded dark.

The two lateral plates (12), which are separated from one another by the two webs (11), are readily apparent. The typical design, according to the invention, of the lateral plates (12), which are considerably thinner in the axial direction of the cage segment than in the radial direction, becomes clear. It is likewise clear that the end faces of each lateral plate (12) pass through the end of the web (11), so that the next lateral plate (12), which is contiguous therewith can be supported thereon by its entire end face. By this means, torques about the longitudinal axis of each cage segment (14) can be transferred to the adjacent cage segment without the angle between the two cage segments changing significantly.

FIG. 2 shows that a slot (111) is formed in that side of the web (11) facing the observer. On the outer face of the opposite web (11), which faces away from the observer, a key (112) is formed, which can be seen in FIG. 2 in the extension of the lateral plate (12).

### LIST OF REFERENCE CHARACTERS

1 Cage for guiding the roller body 2
11 Web of the cage 1
111 Slot in the outer side of a web (11)
112 Key in the outer side of a web (11), complementary to the slot 111
12 Lateral plate of the cage segment 14
13 Longitudinal axis of the cage 1
14 Cage segments form the cage 1
15 Intermediate wedge between two cage segments 14
151 Connecting faces of the intermediate wedge 15
2 Roller body, rolls on the inner ring 3 and outer ring 4
3 Inner ring of the roller body
4 Outer ring of the roller body

1. Roller bearing with various diameters and with a segmented cage (1) for guiding the roller bodies (2), comprising in each case
an inner ring (3), on which
a plurality of roller bodies (2) can be rolled, which can also be rolled on
an outer ring (4), which is concentric with the inner ring (3),
and
a cage (1), which comprises
a plurality of webs (11),
which are distributed in a uniform manner about the periphery and
are aligned so as to be parallel to the surface of a roller body (2) (1), and
a plurality of lateral plates (12) for connecting the webs (11) and
webs (11) and lateral plates (12) are firmly connected to one another to form cage segments (14), which in each case form a pocket for guiding a roller body (2) and
All cage segments (14) are connected to one another rigidly in pairs only via their relatively large cross-sectional area to form an inherently closed cage (1),
characterised in that
a cage segment (14) consists of at least one web (11) and two lateral plates (12) and
for a small variation of the diameter
the webs (11) and the lateral plates (12) of a cage segment (14) have a limited elasticity, which permits identical cage segments (14) to be rigidly connected in various numbers to form an inherently closed annular cage (1) and
for a relatively large variation of the diameter
Intermediate wedges (15) can be inserted between the webs of adjacent cage segments (14), the connecting surfaces (151) of which to the webs (11) are formed so as to be complementary to the outer sides thereof, and variants of the intermediate wedges (15) with different angles between their two connecting surfaces (151) can be assembled with cage segments (14), which are in each case identical, to form cages (1) with different diameters.

2. Roller bearing according to claim 1, characterised in that frame-shaped cage segments (14) are connected to one another at their webs (11).

3. Roller bearing according to one of the preceding claims, characterised in that the lateral plates (12) are connected at their end faces to the end face of the lateral plates (12) of the adjacent H-shaped cage segment (14).

4. Roller bearing according to one of the preceding claims, characterised in that the cage segments (14) are formed as one-part injection moulding or die casting or another cast part.

5. Roller bearing according to one of the preceding claims, characterised in that the cage segments (14) consist of polyimide or polyphthalamide or polyetherketone (PEK) or polyether ether ketone (PEEK) or polyimide imide (PAI) or polyimide (PI) or phenolic resin or another plastic.

6. Roller bearing according to claim 5, characterised in that
glass fibres and/or
other fibres and/or
glass spheres and/or
other fillers
are incorporated into
the plastic

7. Roller bearing according to at least one of the claims 1 to 3, characterised in that the cage segments (14) consist of
sheet metal or
brass or
grey cast iron or
another steel or another metal.

8. Roller bearing according to claim 7, characterised in that plastic sliding bearings are mounted on at least one of the surfaces by which the cage segment (14) contacts the roller body.

9. Roller bearing according to one of the preceding claims, characterised in that a slot (111) is formed in the outside of the first web (11) of each cage segment and a key (112), which is complementary to said slot (111) is formed on the outer side of the second web (11).

10. Roller bearing according to claim 9, characterised in that the profile of the slot (111) and key (112) is dovetail shaped.

11. Roller bearing according to claim 9, characterised in that, approximately in the centre of the slot (111), a tongue is formed,
which can be inserted into a complementary depression in the centre of the key (112) and
parallel to the longitudinal axis (13) of the cage (1), through the tongue and through the key, there runs a bore, into which a securing pin or a screw fastening can be introduced.

12. Roller bearing according to one of the preceding claims, characterised in that, between the webs of adjacent cage segments (14), intermediate wedges (15) are inserted, of which the connecting surfaces (151) to the webs (11) are formed so as to be complementary to the outer sides of the cage segments.

13. Roller bearing according to claim 12, characterised in that variants of the intermediate wedges (15) with different angles between their two connecting surfaces (151) can be assembled with cage segments (14), which are in each case identical, to form cages (1) with different diameters.

14. Roller bearing according to one of the preceding claims, characterised in that
the webs (11) and the lateral plates (12) of a cage segment (14) have a limited elasticity, which permits identical cage segments (14) to be firmly combined in different numbers to form an inherently closed ring-shaped cage (1).

15. Roller bearing according to one of the preceding claims, characterised in that
the lateral plates (12) of a cage segment (14) are extended beyond one of the two webs (11) and
lie with their extension on the lateral plate (12) of the adjacent cage segment (14), various angles being adjustable between those two lateral plates (12) that lie against one another, and
a particular angle between the two superposed lateral plates (12) being fixable by means of
a detent connection and/or
a screw fastening and/or
a serration and/or
another connection.

16. Roller bearing according to one of the preceding claims, characterised in that
the two webs (11) of a cage segment (14) are arranged close together or merge into one another, and
both lateral plates (12) are connected in an articulated way at both ends to the lateral faces (12) of the adjacent cage segment (14), various angles being adjustable between the mutually connected lateral plates (12), and
a particular angle between the mutually connected lateral plates (12) can be fixed by means of
a detent connection and/or
a screw fastening and/or
a serration and/or
another connection.
